(19) United States
(12) Patent Application Publication
(10) Pub. No.: US 2012/0160680 A1
(43) Pub. Date: Jun. 28, 2012

(54) MICROFLUIDIC SYSTEM AND BUBBLE MANIPULATION METHOD THEREOF

(75) Inventors: SHIH-KANG FAN, HSINCHU (TW); LING-PIN TSAI, KAOHSIUNG CITY (TW)

(73) Assignee: NATIONAL CHIAO TUNG UNIVERSITY, HSINCHU CITY (TW)

(21) Appl. No.: 13/159,746

(22) Filed: Jun. 14, 2011

(30) Foreign Application Priority Data
Dec. 22, 2010 (TW) 99145305

(51) Int. Cl. G01N 27/447

(52) U.S. Cl. 204/451; 204/601

(57) ABSTRACT

A microfluidic system includes a first electrode plate having a first substrate and a first electrode layer, wherein the first electrode layer has a plurality of continuously-arranged driving electrodes; a second electrode plate having a second substrate and a second electrode layer, wherein the second electrode layer corresponds to the first electrode layer; a spacing structure disposed between the first electrode plate and the second electrode plate so as to define a fluidic space therebetween; at least one fluid manipulatably received in the fluidic space, wherein the fluid has at least one gas bubble having a reaction gas thereinside, and the gas bubble is an enclosure structure. An electric potential is applied for driving the fluid and then controlling the position of the gas bubble. A gas breakdown voltage is applied to electrically discharge the gas in the gas bubble.

### BACKGROUND OF THE INVENTION

1. Field of the Invention

The instant invention relates to a microfluidic system and a bubble manipulation method thereof. In particular, the instant invention relates to a microfluidic system which is applied to manipulate bubbles thereinside.

2. Description of Related Art

The quantitative and qualitative analyses of gas exhibit wide applications, including environment monitoring, home safety, chemical controlling, green house monitoring and aeronautics applications. Using gas sensor for quantitative and qualitative analyses of gas would lower the analyzing cost and time. For example, one of the traditional optical gas sensors includes an IR source, a reference light source, a chamber, a light beam splitter and a photodiode. The IR source emits an IR light with a desired wavelength range and the IR light is transmitted and reflected in the chamber. The lights with appropriate wavelengths can penetrate through the light beam splitter and then be received by the photodiode. The intensity difference of the lights caused by the gas absorption can be used to analyze the type of the gas(s) and its/their concentration(s). However, the initial signal of such a traditional optical gas sensor would change due to the environment temperature, pressure, and the materials used. Therefore, the precision and the stability of the traditional optical gas sensor are low. In addition, the volumes of the traditional optical gas sensors are usually large, which hinders the on-site and portable applications.

A chip-type gas sensor has also been developed. However, it needs continuous supplying of gas into the open chamber between two electrodes where the gas is electrically discharged. The characteristic spectrum can hence be detected to analyze the composition and the concentration of the gas(s).

Accordingly, what is needed is a gas analysis system that overcomes the foregoing disadvantages.

### SUMMARY OF THE INVENTION

The instant disclosure provides a bubble-manipulating microfluidic system which comprises a first electrode plate having a first substrate and a first electrode layer disposed on a surface of the first substrate, wherein the first electrode layer has a plurality of continuously-arranged driving electrodes; a second electrode plate having a second substrate and a second electrode layer disposed on a surface of the second substrate, wherein the second electrode layer faces to the first electrode layer; a spacing structure disposed between the first electrode plate and the second electrode plate so as to define a fluidic space therebetween; at least one fluid manipulatably in the fluidic space, wherein the fluid carries at least one gas bubble having a reaction gas thereinside, and the gas bubble is an enclosed environment.

The instant disclosure provides a gas discharging method using the microfluidic system. The gas discharging method includes the steps of:

Step 1: driving and fixing the gas bubble on one of the driving electrodes by applying an electric potential to the first and the second electrode layers;

Step 2: electrically discharging the reaction gas inside the gas bubble by applying a gas breakdown voltage to said one of the driving electrodes.

The instant disclosure provides a gas reaction method using the microfluidic system. The gas reaction includes the steps of:

Step 1: generating a first gas bubble by applying a proper electric potential to the first and second electrode layers from a first gas reservoir provided through a first gas inlet unit;

Step 2: generating a second gas bubble by applying a proper electric potential to the first and second electrode layers from a second gas reservoir provided through a second gas inlet unit;

Step 3: preparing the reaction gas bubble by mixing the first and second gas bubbles driven by applying the electric potential to the first and the second electrode layers;

Step 4: driving and fixing the mixed gas bubble on one of the driving electrodes by applying the electric potential to the first and the second electrode layers;

Step 5: electrically discharging the reaction gas inside the mixed gas bubble by applying a gas breakdown voltage to said one of the driving electrodes.

The gas-bubbles are driven by manipulating the fluid in the microfluidic system. By moving, combining, separating the gas bubbles, the gas can be mixed, diluted, and exhausted. By applying the gas breakdown voltage to the gas, the single chip of the microfluidic system of the instant disclosure can be used to emit at least two characteristic spectra for analyzing the composition and concentration of the gas bubble. Furthermore, the electric-discharging of gas can be used to modify the surface of the chip. Still further, the chip of the microfluidic system can perform as a micro lithography apparatus and a micro reactor.

For further understanding of the instant invention, reference is made to the following detailed description illustrating the embodiments and examples of the instant invention. The description is for illustrative purpose only and is not intended to limit the scope of the claim.

### BRIEF DESCRIPTION OF THE DRAWINGS

FIG. 1 shows the microfluidic system of the instant disclosure.

FIGS. 1A and 1B show the bubble moving in the microfluidic system of the instant disclosure.

FIG. 2 shows that the gas is electrically discharged when the gas breakdown voltage is applied according to the instant disclosure.

FIG. 3A shows the spacer electrodes which are used to stabilize the gas bubbles according to the instant disclosure.

FIG. 3B shows the structural walls which are used to stabilize the gas bubbles according to the instant disclosure.

FIG. 4 shows the flow chart of the gas analysis method according to the instant disclosure.

FIG. 5 shows the flow chart of the micro lithography method according to the instant disclosure.

FIG. 6 shows the flow chart of the surface modification method according to the instant disclosure.

FIG. 7 shows the flow chart of the gas reaction method according to the instant disclosure.

FIG. 8 shows the spectrum of Ar gas which is obtained using the microfluidic system of the instant disclosure.

FIG. 9 shows the spectrum of He gas which is obtained using the microfluidic system of the instant disclosure.

FIG. 10 shows the spectrum of mixed Ar/He gas which is obtained using the microfluidic system of the instant disclosure.

### DETAILED DESCRIPTION OF THE PREFERRED EMBODIMENTS

The instant invention provides a bubble-manipulating microfluidic system and a bubble manipulation method thereof. By driving the fluid of the instant microfluidic system, the gas bubble(s) can be driven and mixed. Furthermore, the gas bubble, which is regarded as an enclosed environment, can be electrically discharged by applying a gas breakdown voltage to generate, for example, plasma. Therefore, the electrically discharged gas can be applied to gas analysis, thin film deposition, or other plasma-related technologies. The microfluidic system of the instant disclosure is implemented on a single tiny chip system facilitating portable gas analysis applications.

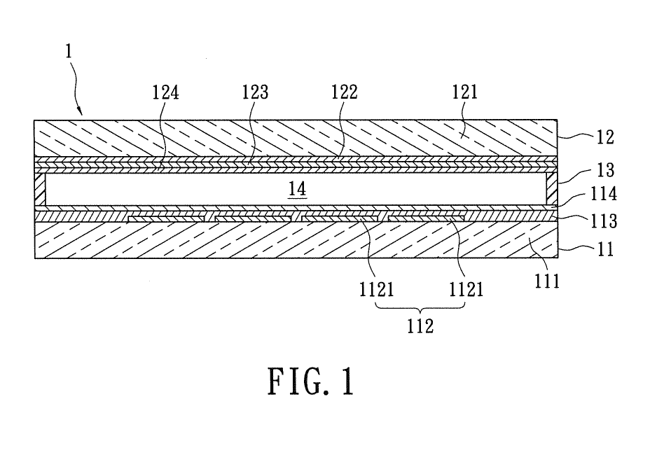

Please refer to FIGS. 1 and 1A; the microfluidic system 1 of the instant disclosure comprises a first electrode plate 11, a second electrode plate 12 and a spacing structure 13. The spacing structure 13 is sandwiched between the first electrode plate 11 and the second electrode plate 12 so as to define a fluidic space 14 (i.e., a space for fluid flowing) between the first electrode plate 11 and the second electrode plate 12. At least one liquid 2, i.e., a fluid, is manipulatably accommodated in the fluidic space 14. Furthermore, the liquid 2 may carry at least one gas bubble 3 which has a reaction gas thereinside. In other words, an electric potential applied to the first electrode plate 11 and the second electrode plate 12 creates an electric field through the liquids 2 causing the liquid 2 to move in the fluidic space 14. Therefore, the gas bubble 3 can be driven due to the movement of the liquid 2. In the exemplary embodiment, the spacing structure 13 includes a frame and/or a plurality of separated pillars.

In detail, the first electrode plate 11 substantially has a first substrate 111 and a first electrode layer 112 disposed on a surface of the first substrate 111. Similarly, the second electrode plate 12 has a second substrate 121 and a second electrode layer 122 disposed on a surface of the second substrate 121. In addition, the first and the second substrates 111, 121 are rectangular plates made of silicon, PDMS (poly-dimethylsiloxane), PET (polyethylene terephthalate), PEN (polyethylene naphthalate), flexible polymer, or other insulating materials. The first and the second substrates 111, 121 can be preferably made of glass. Because of the low roughness of the glass surface, the driving potential of the microfluidic system 1 can be reduced. In the exemplary embodiment, the first and the second substrates 111, 121 are glass substrates.

The first and the second electrode layers 112, 122 are arranged correspondingly to face to each other. The first and the second electrode layers 112, 122 can be made of conductive materials, such as Cr, Cu, or other metals; conductive polymeric materials, such as PEDOT: PSS (poly (3,4-ethylenedioxythiophene) polystyrenesulfonate); or conductive oxides, such as Indium Tin Oxide (ITO). The first electrode layer 112 is patterned to form a plurality of continuously-arranged driving electrodes 1121; in other words, the electrically insulated driving electrodes 1121 are arranged in series defining a path in the fluidic space 14. The second electrode layer 122 can be an unpatterned electrode. By applying an electric potential on the driving electrodes 1121 and the second electrode layer 122, the liquid 2 and the gas bubble 3 can move along the driving electrodes 1121. Specifically, while applying an electric potential to selected driving electrode(s) 1121 of the first electrode layer 112 and the second electrode layer 122, the liquid 2 is driven towards the electric field, and thus to push away the gas bubble 3.

Please refer to FIGS. 1 and 1A; the first electrode plate 11 further has a first dielectric layer 113 disposed on top of the first electrode layer 112 and the first dielectric layer 113 covers the driving electrodes 1121. Similarly, the second electrode plate 12 further has a second dielectric layer 123 disposed on top of the second electrode layer 122; in other words, the second dielectric layer 123 covers the second electrode layer 122. The first and second dielectric layers 113, 123 can be made of Parylene, positive photoresist materials, negative photoresist materials, dielectric materials of high dielectric constants or low dielectric constants. In the instant disclosure, the first and second dielectric layers 113, 123 are made of a commercial photoresist product “SU-8”.

Moreover, the first electrode plate 11 further has a first hydrophobic layer 114 on the first dielectric layer 113. Similarly, the second electrode plate 12 further has a second hydrophobic layer 124 on the second dielectric layer 123. The first and second hydrophobic layers 114, 124 can be made of hydrophobic materials, such as Teflon, for driving the liquid 2 more efficiently. The hydrophobic layer 114 (124) can be called as a low friction layer because of its low friction behavior to the liquid 2. Alternatively, the first and second hydrophobic layers 114, 124 can be respectively disposed on the first electrode layer 112 and the second electrode layer 122 without the dielectric layers 113, 123.

Please refer to FIG. 1A; the gas bubble 3 is fixed on a selected driving electrode 1121. In the microfluidic system of the instant disclosure, the fluid 2 would be driven to flow along the fluidic space 14 by DEP (dielectrophoresis) or EWOD (electrowetting-on-dielectric) principles. In general, in the case that the fluid 2 is a kind of dielectric liquid, the fluid 2 can be driven by the DEP principle. Alternatively, in the case that the fluid 2 is a kind of conductive liquid, the fluid 2 can be driven by the DEP or/and the EWOD principles. However, some kinds of the dielectric fluid 2 can be driven by the EWOD principle. In the embodiment, the fluid 2 is dielectric silicone oil which can be driven by the DEP principle. The EWOD and DEP forces directly drive the fluid 2 and indirectly push away the gas bubble 3. For example, when the electric potential is applied on the right three driving electrodes 1121, the fluid 2 is moved toward the right three driving electrodes 1121 of a high electric field and thus the gas bubble 3 is pushed toward the driving electrode 1121 on the left side; finally, the gas bubble 3 is located on the driving electrode 1121 on the left side (FIG. 1A). In other words, when the selected driving electrode 1121 has a lower electric field than other driving electrodes 1121, the fluid 2 is moved toward and located on the driving electrodes 1121 of a higher electric field and the gas bubble 3 is pushed toward and located on the driving electrode 1121 of a lower electric field.

Similarly, the position of the gas bubble 3 can be adjusted by driving the fluid 2 toward the driving electrode 1121 of a high electric field. Please refer FIG. 1A; the gas bubble 3 is originally located on the first driving electrode 1121 on the left side, where no electric potential is applied. In accordance with FIG. 1B, when a sufficient electric potential is applied to the first, the second driving electrodes 1121 on the left side and the first driving electrode 1121 on the right side, the fluid 2 are attracted to the driving electrodes 1121 of the high electric field. Thus, the gas bubble 3 is pushed by the movement of the fluid 2 to the driving electrode 1121 which has a lower electric field (i.e., no electric potential is applied). Accordingly, the position of the gas bubble 3 can be manipulated by applying the electric potential on driving electrodes 1121 to drive the fluid 2.

The gas electric discharging method of the microfluidic system 1 of the instant disclosure is introduced below.

Step 1 is applying the electric potential to the first and the second electrode layers 112, 122 so as to drive and then locate the gas bubble 3 on one of the driving electrodes 1121, as shown in FIG. 1A.

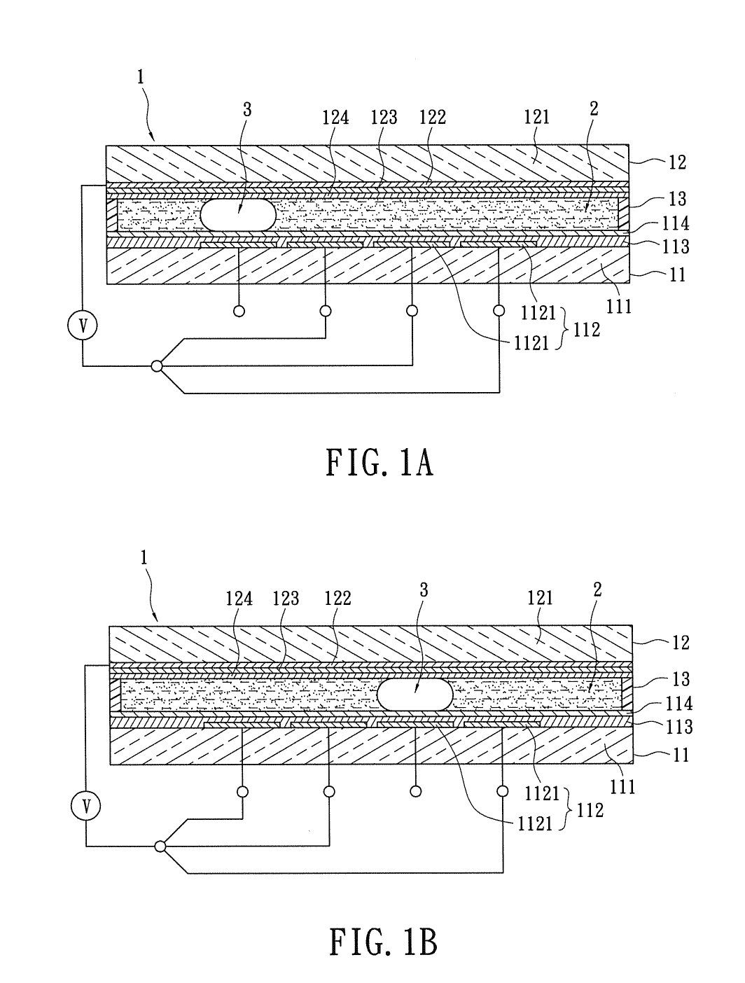

Next step is applying a gas breakdown voltage (i.e., ignition voltage) to said driving electrode 1121 having the gas bubble 3 thereon so as to electrically discharge the reaction gas inside the gas bubble 3, as shown in FIG. 2. Please note that the microfluidic system 1 illustrated in FIG. 2 only has the first and the second electrode layers 112, 122 and the first and second hydrophobic layers 114, 124, i.e., without the dielectric layers 113, 123. To discharge the bubble, an intermittent power supply system, such as pulses, can be used to input the desired energy through the driving electrode 1121 having the gas bubble 3 thereon. Alternatively, a laser, acoustic wave or other electronic devices providing voltage can be applied to the reaction gas so as to reach a desired electric field and to electrically discharge the reaction gas. Taking Ar (Argon) or He (Helium) gas as an example, an electric field created by applying an electric potential on two electrodes (i.e., the first and the second electrode layers 112, 122) across a gap of 50 μm therebetween can result in the electric discharging of Ar gas or He gas. In other words, the reaction gas filled in the gas bubble 3 can be electrically discharged by applying the gas breakdown voltage on the first and the second electrode layers 112, 122 so as to create plasma (or called as microplasma) or to emit the characteristic spectrum of the reaction gas.

In detail, the controlling unit can simultaneously increase the gas breakdown voltage and the electric potential until the reaction gas in the gas bubble 3 is electrically discharged. Furthermore, when the electric discharging of the reaction gas occurs, the gas bubble 3 would be attracted toward the high electric field. Accordingly, during the electric discharging of the reaction gas, the electric potential applied on the driving electrodes 1121 having the fluid 2 thereon can be turned off for avoiding the unstable state of the electric-discharged reaction gas. In addition, the microfluidic system 1 of the instant disclosure can further have a spacer unit 15 around the fluidic space 14. For example, the spacer unit 15 can be structural walls 15B constructed by photoresist to stabilize the electric-discharged reaction gas.

As shown below, the gas discharging method can be applied to gas-analysis.

The microfluidic system 1 can have at least one gas inlet unit, for example, a first gas inlet unit and a second gas inlet unit. Specifically, the gas inlet unit can be a gas inlet tube connected to the second electrode plate 12 or gas reservoir 16. The first gas inlet unit and the second gas inlet unit can be respectively used to store or provide first gas (i.e., a carrier gas for the reference of gas-analysis) and the second gas (i.e., the unknown gas). The first gas can be inert gas, such as He gas, Ne gas or Ar gas. The first and second gases are provided to the fluid 2 to form a first gas bubble and a second gas bubble.

Next step is applying an electric potential to the first and the second electrode layers 112, 122 to drive the fluid 2 so as to move the first and the second gas bubbles to contact and combine with each other. After combining the first and the second gas bubbles as a single gas bubble, the first and the second gases are mixed with each other to form the reaction gas inside the single reaction gas bubble. In other words, the fluid 2 can be driven due to high electric field so that the first and the second gas bubbles can be pushed toward each other. Thus, the two gas bubbles can combine together when they are on the same driving electrode 1121. Then the combined reaction gas bubble having the mixture of the first and the second gases (i.e., the reaction gas) is fixed on one of the driving electrodes 1121 and further a gas breakdown voltage is applied on said one of the driving electrodes 1121. As a result, the reaction gas is electrically discharged and thus the spectrum of the reaction gas is emitted. The generated spectrum of the reaction gas can be transmitted to an optical emission spectroscopy (OES) by optical fibers. By analyzing the generated spectrum of the reaction gas and the characteristic spectrum of the first gas, the unknown second gas can be identified.

For mixing the first and the second gases in a fixing volume, the above-mentioned method further includes the following steps after the step of mixing the first and the second gases.

Step of applying the electric potential to the first and the second electrode layers 112, 122 is introduced to drive the fluid 2 so as to separate the combined gas bubble as at least two separated gas bubbles. In the step, the fluid 2 is driven to move and thus to “split” and to separate the combined gas bubble as at least two separated gas bubbles. The combined gas bubble is separated as two separated gas bubbles so that the first and the second gases are mixed in the fixing volume because each separated gas bubble has the same volume with the first or second gas bubble. In other words, one of the separated gas bubbles has a first gas mixture having 50% first gas and 50% second gas, and the other of the separated gas bubbles has a second gas mixture having 50% first gas and 50% second gas.

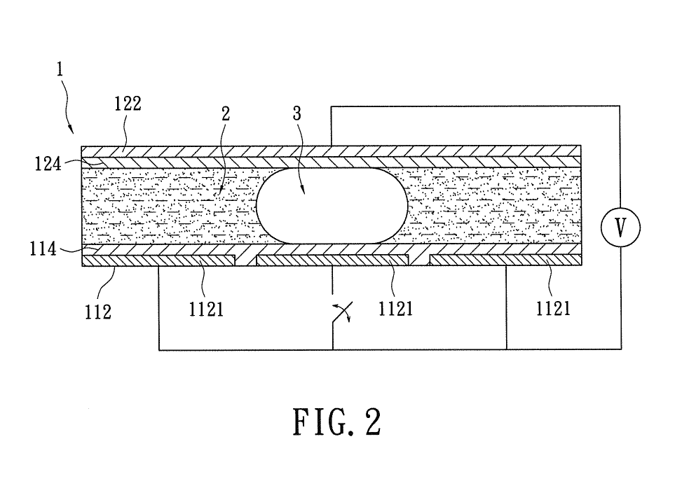

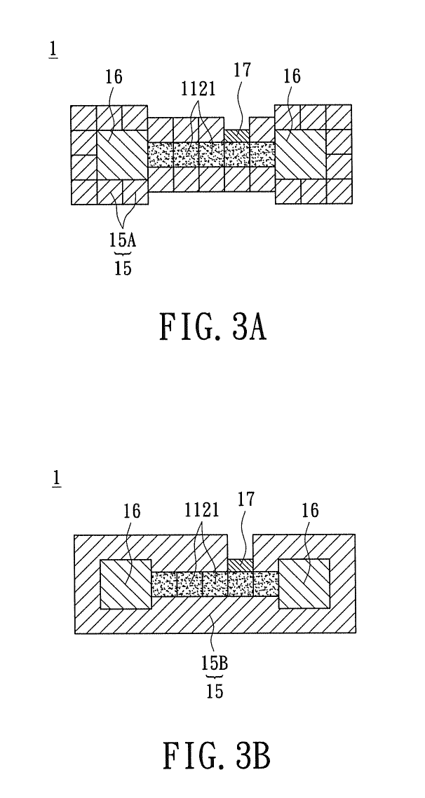

Next step is providing a gas outlet unit 17 (as shown in FIGS. 3A, 3B) to exhaust unwanted gas mixture. For example, the gas mixture in one of the separated gas bubbles is provided for gas quantitative analysis and the gas mixture in another one of the separated gas bubbles can be exhausted through the gas outlet unit 17 formed on the side of the driving electrodes 1121.

Please refer to FIG. 3A, the microfluidic system 1 has a plurality of spacer electrodes 15A (i.e., the spacer unit 15) around the driving electrodes 1121. The spacer electrodes 15A can be applied electric potential thereon and a high electric field can be formed on the spacer electrodes 15A. The high electric field formed around the driving electrodes 1121 can help the gas bubble 3 to maintain its position on the driving electrode 1121.

On the other hand, the microfluidic system 1 can have structural walls 15B (i.e., the spacer unit 15) constructed by photo resist and the structural walls 15B are formed around the driving electrodes 1121. In the embodiment, the structural walls 15B can be formed on the second electrode plate 12 to surround the driving electrodes 1121. To sum up, the spacer electrodes 15A having a high electric field or the structural walls 15B can be used to maintain the position of the gas bubble 3 and to keep the movement of the gas bubble 3 along the passage defined by the driving electrodes 1121.

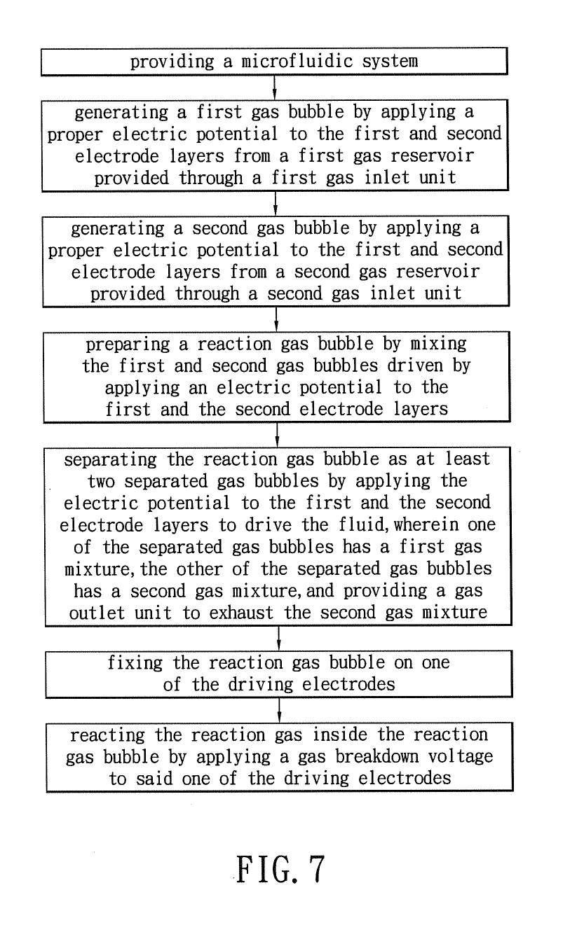

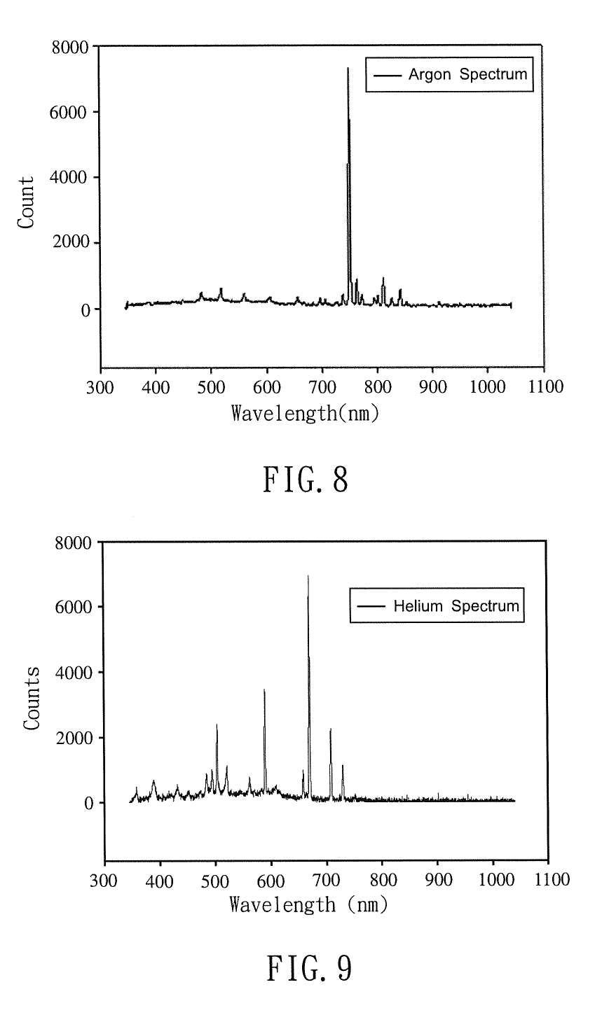

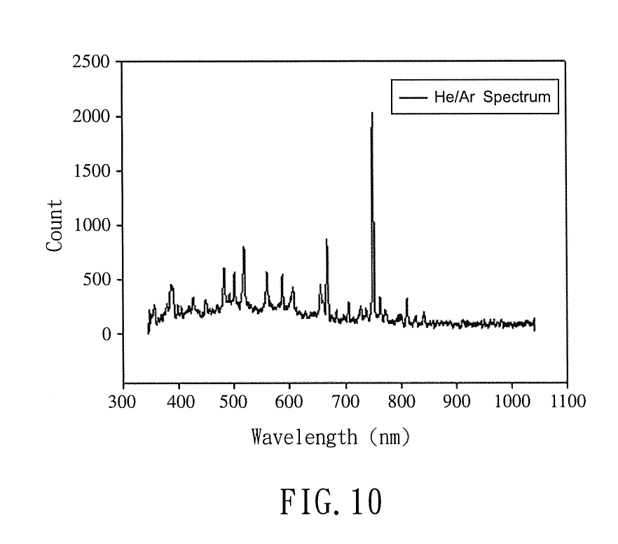

Please note that the method just described for mixing two gases is an exemplary embodiment. The microfluidic system 1 of the instant disclosure can be applied to an analysis for single gas or for more than three kinds of gases. Additionally, the above-mentioned method can repeat the step of mixing and separating the gas bubbles for diluting the concentration of the unknown gas. Therefore, the analyzed results of the unknown gas in different concentrations are determined. As shown in FIG. 8, the spectrum of Ar gas is obtained using the microfluidic system 1 of the instant disclosure. As shown in FIG. 9, the spectrum of He gas is obtained using the microfluidic system 1 of the instant disclosure. As shown in FIG. 10, two gases of Ar gas and He gas are mixed and separated by the above-mentioned method and then spectrum of the gas mixture is obtained.

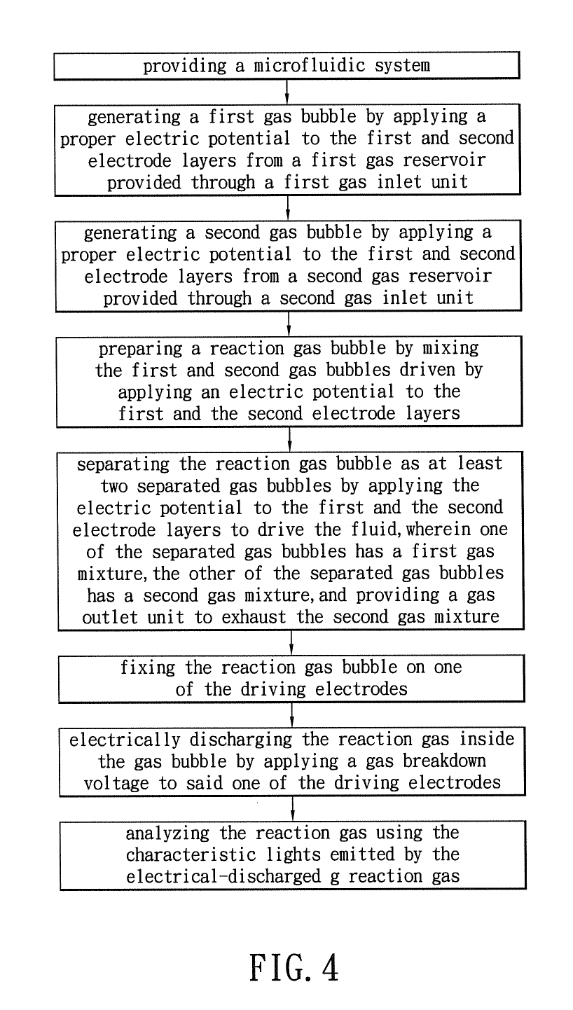

Please refer to FIG. 5; the gas discharging method of the microfluidic system 1 can be applied to micro-lithography applications.

Similarly, the microfluidic system 1 can have at least one gas inlet unit which can be used to store or provide gas into the fluid 2 to form a gas bubble. The gas bubble 3 can be combined and/or separated as described foregoing. On the other hand, the reaction gas inside the gas bubble 3 can be single gas or a gas mixture.

When the gas bubble 3 is positioned on a desired driving electrode 1121, the gas breakdown voltage is applied on said desired driving electrode 1121 so as to electrically discharge the reaction gas. The characteristic spectrum of the reaction gas is generated in the electric discharging procedure and the generated characteristic spectrum can be used to modify the corresponding light-sensitive materials, i.e., the exposure reaction. Consequently, by adjusting the electric potential applied on the driving electrodes 1121, the gas bubble 3 having electric-discharged gas moves along the driving electrodes 1121 to expose the light-sensitive material corresponding to the driving electrodes 1121, which is like a stepper exposing apparatus.

On the other hand, there can be a plurality of gas bubbles 3 containing different gases at different concentrations in the fluid 2. Thus, the gas bubbles 3 can be used to emit different characteristic spectrums. The characteristic spectrums can be applied to modify the corresponding materials. In other words, for different light-sensitive materials, user can choose the gas bubble 3 which emits corresponding characteristic spectrum to modify the material and thus the modified material can be stripped or etched. Hence, the microfluidic system 1 can perform as a lithography system.

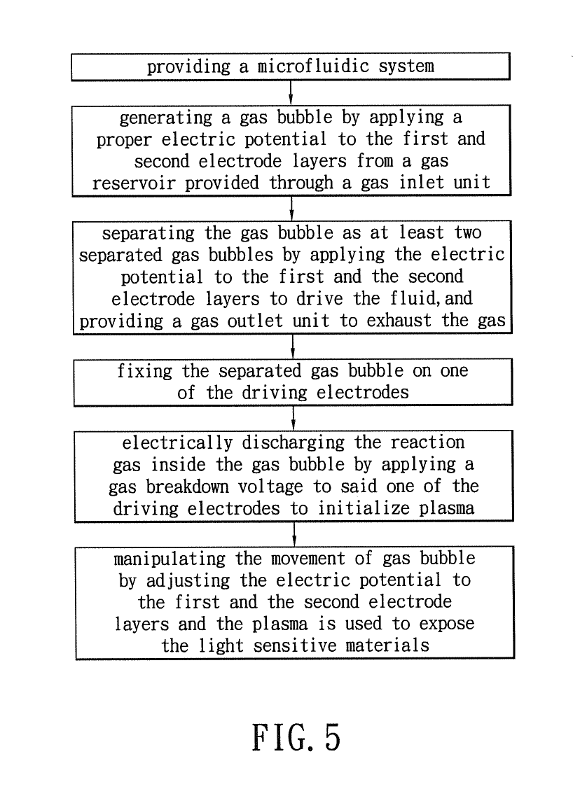

Please refer to FIG. 6; the gas discharging method of the microfluidic system 1 can be applied to surface modification applications.

Similar to the foregoing embodiment, the microfluidic system 1 can have at least one gas inlet unit which can be used to store or provide gas into the fluid 2 to form a gas bubble. The gas bubble 3 can be combined and/or separated as described foregoing. On the other hand, the reaction gas inside the gas bubble 3 can be single gas or gas mixture.

When the gas bubble 3 is positioned on a desired driving electrode 1121, the gas breakdown voltage is applied on said desired driving electrode 1121 so as to electrically discharge the reaction gas and thus to initiate plasma.

By adjusting the electric potential applied to the driving electrodes 1121, the gas bubble 3 having glow plasma moves along the driving electrodes 1121. The glow plasma can be used to modify the surface of the driving electrodes 1121, for example, a thin film can be deposited on the surface of the driving electrodes 1121.

Alternatively, users can first control the gas bubble 3 to move on a selected driving electrode 1121. Then, the gas breakdown voltage is applied and thus the surface of the selected driving electrode 1121 can be modified by a thin film thereon.

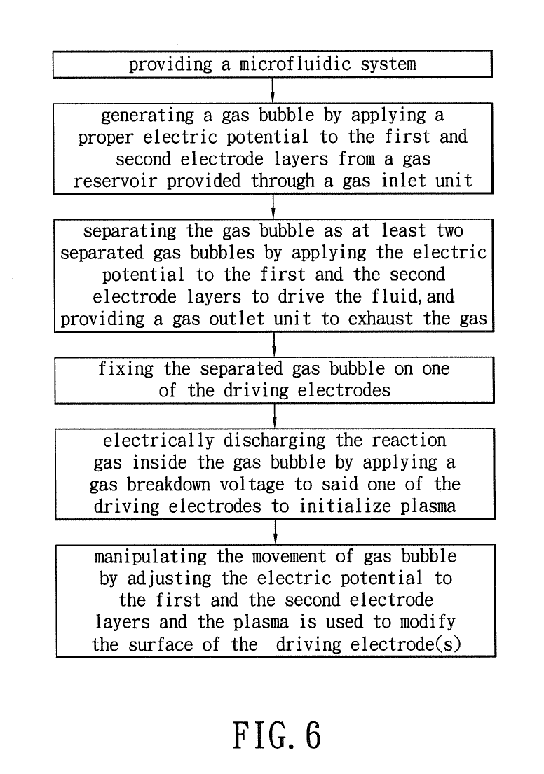

Please refer to FIG. 7; the gas discharging method of the microfluidic system 1 can be applied to gas reactions.

The microfluidic system 1 can hold a first gas inlet unit and a second gas inlet unit. The first gas inlet unit and the second gas inlet unit can be respectively used to store or provide first gas and the second gas to form a first gas bubble and a second gas bubble.

Next step is applying an electric potential to the first and the second electrode layers 112, 122 to drive the fluid 2 so as to move the first and the second gas bubbles to contact and combine with each other. After combining the first and the second gas bubbles as a single gas bubble, the first and the second gases are mixed with each other to form the reaction gas inside the single gas bubble. Then, the combined gas bubble having the mixture of the first and the second gases is fixed on one of the driving electrodes 1121 and further a gas breakdown voltage is applied on said one of the driving electrodes 1121. As a result, the reaction gas is electrically discharged and thus a chemical reaction of the first and the second gases is generated. In other words, the enclosure structure of the gas bubble 3 performs as a micro reaction room which is suitable for precise reactions.

In addition, the gas reaction method further includes the controlling steps of separating gas bubble, exhausting gas or moving gas bubble, which can be referenced as above.

To sum up, the fluid of the microfluidic system can be driven to control the movement of the gas bubbles. By moving, combining, separating the gas bubbles, the gas can be mixed, diluted, exhausted. Further by applying the gas breakdown voltage to the gas, the electric-discharging of gas, reaction of gases can be generated.

The instant invention has the following characteristics.

1. The microfluidic system of the instant invention can control the position of the gas bubble by driving the fluid. Therefore, the gas bubbles can be combined or separated by moving the gas bubbles.

2. The instant invention can provide a portable gas-analyzing chip, a micro gas reaction apparatus or a micro lithography apparatus, but not restricted thereby.

3. For applications of gas analyses, the system requires less gas than traditional apparatus. Thus, the analyzing time is decreased. The instant system is portable so as to achieve the “in-time” analysis.

The description above only illustrates specific embodiments and examples of the instant invention. The instant invention should therefore cover various modifications and variations made to the herein-described structure and operations of the instant invention, provided they fall within the scope of the instant invention as defined in the following appended claims.

What is claimed is:

1. A bubble-manipulating microfluidic system, comprising:
a first electrode plate having a first substrate and a first electrode layer disposed on a surface of the first substrate, wherein the first electrode layer has a plurality of continuously-arranged driving electrodes;
a second electrode plate having a second substrate and a second electrode layer disposed on a surface of the second substrate, wherein the second electrode layer faces to the first electrode layer;
a spacing structure disposed between the first electrode plate and the second electrode plate so as to define a fluidic space therebetween;
at least one fluid manipulatably in the fluidic space, wherein the fluid carries at least one gas bubble having a reaction gas thereinside, and the gas bubble is an enclosed environment.

2. The microfluidic system as claimed in claim 1, wherein the first electrode plate further has a first dielectric layer disposed on the first electrode layer, and the second electrode plate further has a second dielectric layer disposed on the second electrode layer.

3. The microfluidic system as claimed in claim 2, wherein the first electrode plate further has a first hydrophobic layer disposed on the first dielectric layer, and the second electrode plate further has a second hydrophobic layer disposed on the second dielectric layer.

4. The microfluidic system as claimed in claim 1, wherein the first electrode plate further has a first hydrophobic layer disposed on the first electrode layer, and the second electrode plate further has a second hydrophobic layer disposed on the second electrode layer.

5. The microfluidic system as claimed in claim 1, wherein the enclosed environment is defined by the first electrode plate, the second electrode plate and the fluid.

6. The microfluidic system as claimed in claim 1, further comprising at least one gas inlet unit, a gas outlet unit and a spacer unit.

7. A bubble manipulation method, comprising the steps of:
providing a bubble-manipulating microfluidic system, wherein the bubble-manipulating microfluidic system includes a first electrode plate having a first substrate and a first electrode layer, a second electrode plate having a second substrate and a second electrode layer, a spacing structure disposed between the first electrode plate and the second electrode plate and at least one fluid manipulatably in a fluidic space defined between the first electrode plate and the second electrode plate, the fluid carries at least one gas bubble having a reaction gas thereinside; wherein the first electrode layer has a plurality of continuously-arranged driving electrodes, and the second electrode layer faces to the first electrode layer;
driving the fluid in the fluidic space by applying an electric potential to the first and the second electrode layers; and
simultaneously pushing the gas bubble due to the movement of the fluid.

8. The method as claimed in claim 7, further comprising the steps of:
driving and fixing the gas bubble on one of the driving electrodes by applying the electric potential to the first and the second electrode layers; and
electrically discharging the reaction gas inside the gas bubble by applying a gas breakdown voltage to said one of the driving electrodes.

9. The method as claimed in claim 8, wherein in the step of providing a bubble-manipulating microfluidic system, the method further includes the steps of:
generating a first gas bubble by applying a proper electric potential to the first and second electrode layers from a first gas reservoir provided through a first gas inlet unit;
generating a second gas bubble by applying a proper electric potential to the first and second electrode layers from a second gas reservoir provided through a second gas inlet unit; and
preparing a reaction gas bubble by mixing the first and second gas bubbles driven by applying an electric potential to the first and the second electrode layers.

10. The method as claimed in claim 9, wherein after the step of mixing the first and the second gas bubbles, the method further includes the steps of:
separating the reaction gas bubble as at least two separated gas bubbles by applying the electric potential to the first and the second electrode layers to drive the fluid, wherein one of the separated gas bubbles has a first gas mixture, the other of the separated gas bubbles has a second gas mixture; and
providing a gas outlet unit to exhaust the second gas mixture.

11. The method as claimed in claim 8, wherein after the step of applying a gas breakdown voltage to electrically discharge the reaction gas, the method further includes the step of:
driving the gas bubble with the electrically discharging reaction gas along the driving electrodes by adjusting the electric potential applied to the first and the second electrode layers.

12. The method as claimed in claim 7, wherein in the step of providing a bubble-manipulating microfluidic system, the method further includes the steps of:
generating a first gas bubble by applying a proper electric potential to the first and second electrode layers from a first gas reservoir provided through a first gas inlet unit;
generating a second gas bubble by applying a proper electric potential to the first and second electrode layers from a second gas reservoir provided through a second gas inlet unit;
preparing a reaction gas bubble by mixing the first and second gas bubbles driven by applying an electric potential to the first and the second electrode layers;
driving and fixing the reaction gas bubble on one of the driving electrodes by applying the electric potential to the first and the second electrode layers; and
reacting the reaction gas inside the reaction gas bubble by applying a gas breakdown voltage to said one of the driving electrodes.

13. The method as claimed in claim 12, wherein after the step of mixing the first and the second gas bubbles, the method further includes the steps of:
separating the reaction gas bubble as at least two separated gas bubbles by applying the electric potential to the first and the second electrode layers to drive the fluid, wherein one of the separated gas bubbles has a first gas mixture, the other of the separated gas bubbles has a second gas mixture; and
providing a gas outlet unit to exhaust the second gas mixture.
